(19) United States
(12) Patent Application Publication
(10) Pub. No.: US 2012/0166934 A1
(43) Pub. Date: Jun. 28, 2012

(54) INFORMATION PROCESSING APPARATUS, LAYOUT GENERATING METHOD, AND COMPUTER PROGRAM PRODUCT

(75) Inventor: Yuka Kihara, Kanagawa (JP)

(73) Assignee: RICOH COMPANY, LIMITED, Tokyo (JP)

(21) Appl. No.: 13/327,204

(22) Filed: Dec. 15, 2011

(30) Foreign Application Priority Data
Dec. 24, 2010 (JP) 2010-288157

(51) Int. Cl. G06F 17/00

(52) U.S. Cl. 715/234

(57) ABSTRACT

An information processing apparatus includes: a converting unit that converts acquired Web page information into bitmap data; a display control unit that displays, on a display unit on which the Web page information has been displayed, an image of the converted bitmap data by switching from the Web page information to the image; a receiving unit that receives an input for designating an output region as an output target from the displayed image; an extracting unit that extracts a corresponding region corresponding to the received output region from the bitmap data; and a layout generating unit that generates layout information representing a layout to arrange the extracted corresponding region on a page to be output.

### CROSS-REFERENCE TO RELATED APPLICATIONS

The present application claims priority to and incorporates by reference the entire contents of Japanese Patent Application No. 2010-288157 filed in Japan on Dec. 24, 2010.

### BACKGROUND OF THE INVENTION

1. Field of the Invention

The present invention relates to an information processing apparatus, a layout generating method, and a computer program product.

2. Description of the Related Art

Generally, when a user wants to print part of data from a Web page displayed on a display screen, which is described in the HyperText Markup Language (HTML) or the like, it is difficult for the user to delete unnecessary data such as a banner advertisement or to print only a desired region.

In order to solve this problem, Japanese Patent Application Laid-open No. 2007-094950 discloses a printing apparatus that prints out an image of an arbitrary region designated by the user. That is, Japanese Patent Application Laid-open No. 2007-094950 discloses a method in which a Web page is converted into bitmap data, the bitmap data is displayed on a browser screen in place of the Web page, and a region on the displayed screen designated by the user is output as print data.

However, the printing apparatus disclosed in Japanese Patent Application Laid-open No. 2007-094950 primarily aims to delete unnecessary portions on the Web page and then perform printing. Accordingly, the functionality of the apparatus is not intended to collect only desired images from the Web page and effectively laying out the images. Meanwhile, Web pages including desired contents are frequently printed for use. Accordingly, to reduce the environmental load or to save cost of paper, it is not sufficient to remove useless contents, but it is further required to print the necessary contents with as few sheets of paper as possible.

There is a need to provide an information processing apparatus, a layout generating method, and a computer program product capable of laying out only the contents that a user designates from the Web page.

### SUMMARY OF THE INVENTION

It is an object of the present invention to at least partially solve the problems in the conventional technology.

An information processing apparatus includes: a converting unit that converts acquired Web page information into bitmap data; a display control unit that displays, on a display unit on which the Web page information has been displayed, an image of the converted bitmap data by switching from the Web page information to the image; a receiving unit that receives an input for designating an output region as an output target from the displayed image; an extracting unit that extracts a corresponding region corresponding to the received output region from the bitmap data; and a layout generating unit that generates layout information representing a layout to arrange the extracted corresponding region on a page to be output.

A layout generating method includes: converting acquired Web page information into bitmap data; display controlling to display, on a display unit on which the Web page information has been displayed, an image of the converted bitmap by switching from the Web page information to the image; receiving an input for designating an output region as an output target from the displayed image; extracting a corresponding region corresponding to the received output region from the bitmap data; and generating layout information representing a layout to arrange the extracted corresponding region on a page to be output.

A computer program product includes a non-transitory computer-usable medium having a computer-readable program code embodied in the medium causing a computer to execute: converting acquired Web page information into bitmap data; display controlling to display, on a display unit on which the Web page information has been displayed, an image of the converted bitmap by switching from the Web page information to the image; receiving a designation input of an output region as an output target from the displayed image; extracting a corresponding region corresponding to the received output region from the bitmap data; and generating layout information representing a layout to arrange the extracted corresponding region on a page to be output.

A layout generating method includes: converting acquired Web page information into bitmap data; display controlling to display, on a display unit on which the Web page information has been displayed, an image of the converted bitmap by switching from the Web page information to the image; receiving a designation input of an output region as an output target from the displayed image; extracting a corresponding region corresponding to the received output region from the bitmap data; and generating layout information representing a layout to arrange the extracted corresponding region on a page to be output.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a configuration of a Web page print support system according to the present embodiment;

FIG. 2 is a flowchart illustrating a procedure of a corresponding region extracting process performed by an information processing apparatus;

FIG. 3 is a flowchart illustrating a procedure of a print data generating process performed by an information processing apparatus;

FIG. 4 is a flowchart illustrating details of a layout procedure performed by a layout generating unit;

FIG. 5 is a diagram illustrating an example of a rectangular content;

FIG. 6 is a flowchart schematically illustrating an example of a content arrangement method using a first-fit decreasing-height (FFDH) algorithm;

FIG. 7 is a diagram illustrating an example of the close-packed layout generated by the FFDH algorithm;

FIG. 8 is a diagram illustrating a row in an arrangement region;

FIG. 9A is a diagram illustrating an example in which blocks are arranged over different pages to be output;

FIG. 9B is a diagram illustrating an example in which the blocks are arranged over the different pages to be output;

FIG. 10 is a flowchart illustrating a process of an example of a page layout generating method according to the present embodiment;

FIG. 11 is a flowchart illustrating a procedure of a preview display process;

FIG. 12 is a flowchart illustrating a procedure of a preview display process according to another example; and

FIG. 13 is a diagram for explaining a hardware configuration of an information processing apparatus according to the present embodiment.

### DETAILED DESCRIPTION OF THE PREFERRED EMBODIMENTS

Hereinafter, an exemplary embodiment of an information processing apparatus according to the present invention will be described in detail with reference to the accompanying drawings.

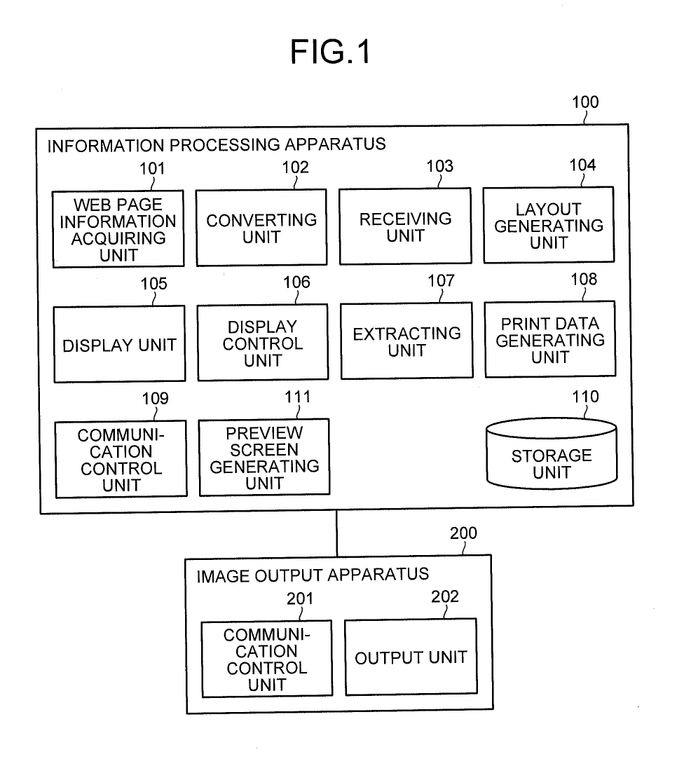

FIG. 1 is a block diagram illustrating a configuration of a Web page print support system according to the present embodiment. The Web page print support system for printing a Web page acquired from a network includes an information processing apparatus 100 and an image output apparatus 200 connected to the information processing apparatus 100 as illustrated in FIG. 1.

First, the information processing apparatus 100 includes a Web page information acquiring unit 101, a converting unit 102, a receiving unit 103, a layout generating unit 104, a display unit 105, a display control unit 106, an extracting unit 107, a print data generating unit 108, a communication control unit 109, a storage unit 110, and a preview screen generating unit 111.

The Web page information acquiring unit 101 acquires Web page information through the communication control unit 109 and stores the acquired Web page information in the storage unit 110. The Web page information acquiring unit 101 displays the acquired Web page information on the display control unit 106 which will be described later.

The converting unit 102 converts the Web page information acquired by the Web page information acquiring unit 101 into bitmap data. For example, the converting unit 102 first captures the Web page information which is displayed on the display unit 105. Then, the converting unit 102 converts the captured Web page information into bitmap data which is a set of cells.

The display control unit 106 acquires the Web page information from the storage unit 110, and displays the acquired Web page information on the display unit 105. The display control unit 106 replaces the Web page information displayed on the display unit 105 with an image of the bitmap data having been converted by the converting unit 102, and displays the image of the bitmap data.

The receiving unit 103 receives the designation of an output region that has been designated by the user in the image of the bitmap data displayed on the display unit 105. The output region refers to a region as an output target of the image output apparatus 200. For example, the receiving unit 103 receives a region of an output target, which is included in the images of the bitmap data displayed on the display unit 105, by a rectangular icon operation.

The extracting unit 107 extracts a corresponding region from the bitmap data, and stores the bitmap data of the extracted corresponding region in the storage unit 110. Here, the corresponding region refers to a region on the bitmap data corresponding to the output region designated by the user. For example, the extracting unit 107 receives the output region from the receiving unit 103 that receives an input, determines the corresponding region from the received output region, and extracts the determined corresponding region from the bitmap data.

There is a plurality of methods for the storage unit 110 to store the bitmap data of the extracted corresponding region. In this embodiment, it is assumed that the storage unit 110 stores the bitmap data of the corresponding region in a local folder in which bitmap data is already stored. The extracting unit 107 may store the bitmap data of the corresponding region in a predetermined region on a server or a cloud cluster in addition to the storage unit 110.

The storage unit 110 accumulates the bitmap data of the corresponding region in a folder in the form of files when the output region is received from the receiving unit 103. Here, the folder may be a predetermined folder or a folder designated by the user.

The storage unit 110 may categorize folders according to structure information such as a hierarchical structure of the Web site from which the Web page information is acquired or the structure of the Web page, and store the bitmap data in the categorized folders. For example, as an example in which the hierarchical structure is used, the storage unit 110 may assign data of lower-level hierarchies belonging to the same upper-level hierarchy to the same folder, and then store the bitmap data of the corresponding region. Further, as an example in which the page information is used, the storage unit 110 may store the bitmap data of the corresponding regions laid out on the same page to be output in the same folder.

The layout generating unit 104 generates layout information (hereinafter, referred to as “layout”) representing the layout in which the corresponding regions extracted by the extracting unit 107 are arranged on the page to be output. Here, the page to be output refers to a page which is to be output by the image output apparatus 200. For example, the page to be output may be a page which is to be printed on one print sheet.

The layout generating unit 104 determines each layout of the bitmap data stored in the same folder by the storage unit 110. When the storage unit 110 stores the bitmap data in a hierarchical structure according to the structure of the Web page, the layout generating unit 104 may lay out the bitmap data of the corresponding region according to the hierarchical structure. For example, when an upper-level folder and a lower-level folder are present in the storage unit 110, the layout generating unit 104 lays out the bitmap data present in the upper-level folder at a portion of the page to be output higher in level than the bitmap data present in the lower-level folder.

By classifying and arranging the bitmap data of the extracted corresponding region and managing the folder through the storage unit 110, the structure of the Web page is reflected on the layout result.

The print data generating unit 108 generates print data according to the layout generated by the layout generating unit 104. Here, the print data refers to data which is to be output by the image output apparatus 200. The print data includes one or a plurality of pages to be output.

The communication control unit 109 communicates with the World Wide Web (WWW) and receives Web page information. The communication control unit 109 communicates with the image output apparatus 200, and transmits the print data generated by the print data generating unit 108 to the image output apparatus 200.

Next, the details of the image output apparatus 200 will be described. The image output apparatus 200 includes a communication control unit 201 and an output unit 202 as illustrated in FIG. 1.

The communication control unit 201 communicates with the information processing apparatus 100 and receives the print data from the information processing apparatus 100.

The output unit 202 outputs the print data received from the information processing apparatus 100 via the communication control unit 201 according to previously received print setting. For example, the output unit 202 prints the print data on a print sheet.

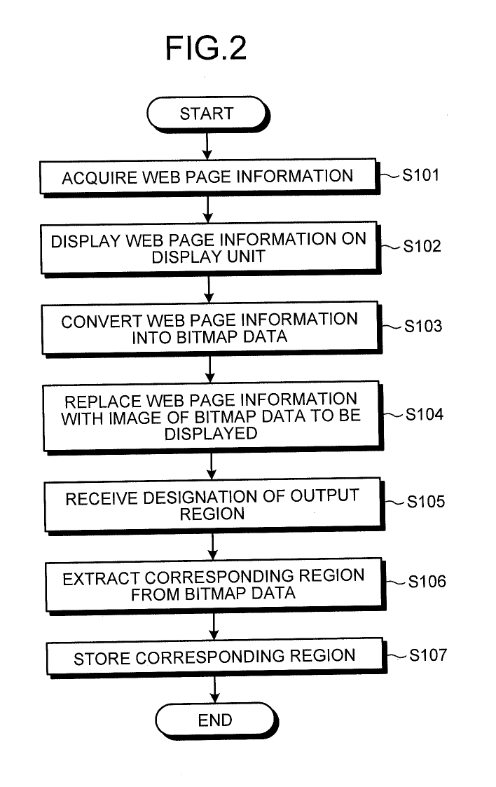

Next, a description will be made in connection with a procedure of a corresponding region extracting process for extracting the corresponding region through the information processing apparatus 100 having the above described configuration. FIG. 2 is a flowchart illustrating a procedure of a corresponding region extracting process performed by the information processing apparatus 100.

The Web page information acquiring unit 101 acquires Web page information from the WWW via the communication control unit 109 (step S101). The Web page information acquiring unit 101 stores the acquired Web page information in the storage unit 110.

The display control unit 106 displays the Web page information acquired by the Web page information acquiring unit 101 on the display unit 105 (step S102). The converting unit 102 converts the Web page information acquired by the Web page information acquiring unit 101 into bitmap data (step S103).

The display control unit 106 replaces the Web page information displayed on the display unit 105 with an image of the bitmap data converted by the converting unit 102, and then displays the image of the bitmap data (step S104).

The receiving unit 103 receives the designation of the output region (step S105). For example, the receiving unit 103 receives the designation of the output region on the image of the bitmap data by a variable-size rectangular icon operation.

The extracting unit 107 extracts the corresponding region from the bitmap data (step S106). The extracting unit 107 stores the extracted corresponding region in the storage unit 110 (step S107).

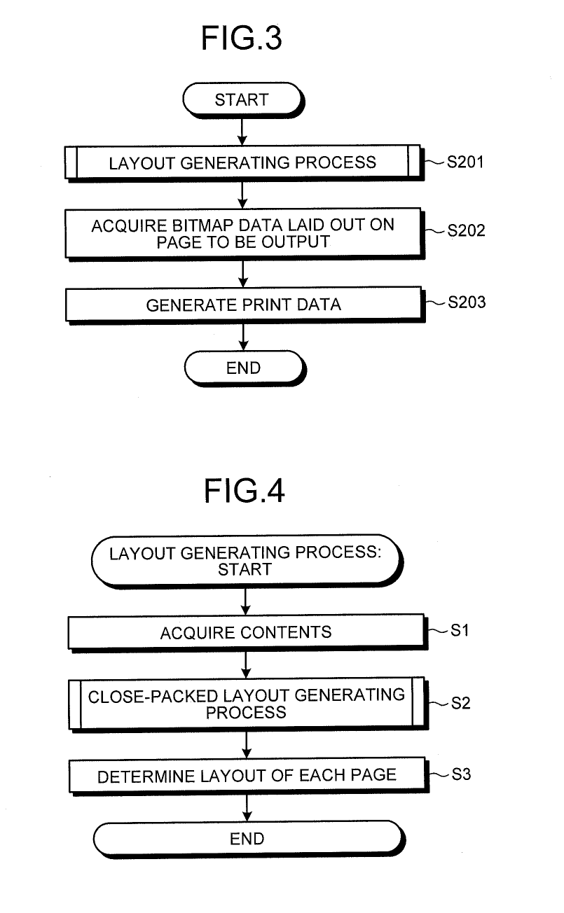

Next, a description will be made in connection with a procedure of a print data generating process performed by the information processing apparatus 100. FIG. 3 is a flowchart illustrating a procedure of a print data generating process performed by the information processing apparatus 100.

The layout generating unit 104 lays out the bitmap data of the corresponding region extracted by the extracting unit 107 on the page to be output (step S201). Here, the details of a layout method by the layout generating unit 104 will be described. FIG. 4 is a flowchart illustrating the details of a layout procedure performed by the layout generating unit 104.

The layout generating unit 104 acquires the bitmap data of the corresponding region (hereinafter, referred to as “content data”) from the storage unit 110 (step S1). The layout generating unit 104 executes the close-packed layout generating process based on the acquired bitmap data (step S2). The layout generating unit 104 determines a final layout of each page to be output based on the close-packed layout generated in step S2 (step S3). The layout generating unit 104 transfers layout data representing the determined final layout to the print data generating unit 108.

Here, the close-packed layout generating process of step S2 in FIG. 4 will be described in further detail. Data of input contents may have various shapes. However, for the sake of simplicity in the description, it is assumed that content data has a rectangular shape. A minimum rectangle including an image by content data may be used, or a rectangle in which a margin of the image of the content data considered may be used. In the following description, for simplicity, the “image of content data” is simply referred to as “content”.

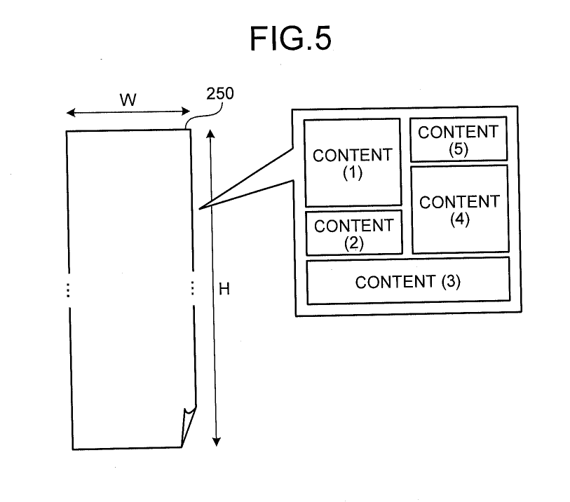

First, a description will be made in connection with an example of a rectangular content. FIG. 5 is a diagram illustrating an example of a rectangular content. As illustrated in FIG. 5, the layout generating unit 104 generates a layout in which a plurality of rectangular contents having various sizes (the width×the height) are arranged in an arrangement region 250 having the width W and the height H. Here, it is assumed that the width W has a finite value, and the height H has an infinitely large value. In the flowchart, the layout represents an arrangement of contents on the printable arrangement region 250 within the page to be output, and the layout data refers to data including information (for example, coordinates information) representing an arrangement of contents in the layout. The page to be output represents a region to display at a time. Partial regions within the arrangement region having the width W are delimited to have a predetermined height h so that each partial region can be displayed at a time. Hereinafter, each partial region with the height h will be referred to as a “page to be output”.

In the close-packed layout of step S2, with respect to a region having a predetermined width and an infinite height, the layout of contents is determined so as to satisfy the following conditions and by considering the best way of arranging a plurality of contents within an area having the smallest possible height:

(1) the shape of a content is rectangular, and the width and the height are rational values;

(2) rotation is not allowed; and

(3) contents do not overlap each other.

Here, the condition (3) specifying that contents do not overlap each other is equivalent to satisfaction of at least one of the following Formulas (1) to (4) on two contents Ci and Cj. In Formulas (1) to (4), the values w and h denote the width and height of a content, respectively, and the values x and y denote an x coordinate and a y coordinate of one end (for example, the bottom left corner) of a content, respectively.

xi+wi≦xj (1)

xj+wj≦xi (2)

yi+hi≦yj (3)

yj+hj≦yi (4)

In the case of determining a formula to employ from among Formulas (1) to (4) on each content, a simple estimate suggests that there are 4(n(n-1)/2) possibilities. This problem is generally referred to as a “packing problem”. Since it belongs to the NP problem, it is very difficult to find a solution in a practical calculation time. For this reason, in the present embodiment, the close-packed layout is generated using a technique of finding an optimum approximate solution obtained by approximating an optimum solution by the simplest possible procedure.

In order to solve the problem, a first-fit decreasing-height (FFDH) algorithm, a next-fit decreasing-height (NFDH) algorithm, and the like have been known as basic algorithms satisfying the above described conditions and having a definite amount of deviation from an evaluated value or an optimum solution. In the present embodiment, the close-packed layout is generated using the FFDH algorithm. The FFDH algorithm is described in, E. G. Coffman, JR., M. R. Garey, D. S. Johonson, R. E. Tarjan (Bell Lab. & Stanford Univ.) “Performance bounds for level-oriented two-dimensional packing algorithms”, SIAM J. Comput, vol. 9., pp 808-826, No. 4, 1980.

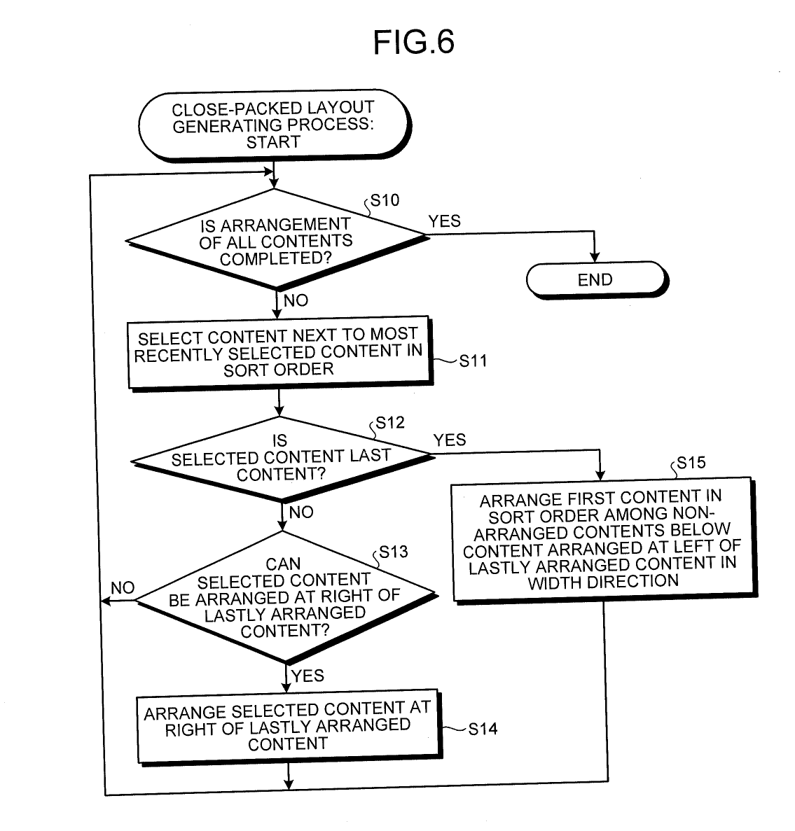

FIG. 6 is a flowchart schematically illustrating an example of a content arrangement method using the FFDH algorithm. According to the FFDH algorithm, contents are first sorted in a descending order of height (length) values, a first content (that is, a content having the highest height (longest length)) which is the first in a sort order is arranged at an arrangement start position of an arrangement region, and the process starts. For convenience of description, a top left corner is set as the arrangement start position.

Before starting the process by the flow chart in FIG. 6, it is assumed that a specific content (for example, the first content in the sort order) is arranged on the arrangement region. Under the assumption that the above mentioned specific content is the lastly arranged content, the process by the flow chart of FIG. 4 starts. In step S10, the layout generating unit 104 determines whether or not arrangement of all contents has been completed. When it is determined that the arrangement of all the contents has not been completed yet, the process proceeds to step S11. However, when it is determined that the arrangement of all the contents has been completed, the layout generating unit 104 ends a series of processes in the flowchart of FIG. 6.

In step S11, the layout generating unit 104 selects the next content which is next to a most recently selected content in the sort order. In step S12, the layout generating unit 104 determines whether or not the content selected in step S11 is the last content in the sort order. When it is determined that the content selected in step S11 is not the last content in the sort order, the layout generating unit 104 proceeds to step S13.

In step S13, the layout generating unit 104 determines whether or not the content selected in step S11 can be arranged at the right of the lastly arranged content. That is, when the width between the right end of the lastly arranged content and the right end of the arrangement region is equal to or more than the width of the content selected in step S11, the layout generating unit 104 determines that the selected content can be arranged at the right of the lastly arranged content. However, when it is determined that the selected content cannot be arranged at the right of the lastly arranged content (No in step S13), the process returns to step S10. When it is determined in step S11 that the arrangement of all the contents has not been completed, in step S11, the layout generating unit 104 selects the next content in the sort order. Then, the process is repeated.

Meanwhile, in step S13, when it is determined in step S13 that the content selected in step S11 can be arranged at the right of the lastly arranged content (Yes in step S13), the layout generating unit 104 moves the process to step S14, where the layout generating unit 104 arranges the content selected in step S11 at the right of the lastly arranged content. Information representing an arrangement position of the content is stored in the storage unit 110. Then, the process returns to step S10.

When it is determined in step S12 that the content selected in step S11 is the last content in the sort order, the layout generating unit 104 moves the process to step S15. In step S15, the layout generating unit 104 left-aligns and arranges a content, which is the first in the sort order (which is highest in height (longest in length)) among non-arranged contents, on a portion of the arrangement region below the content arranged at the left of the lastly arranged content in the width direction. The information representing the arrangement position of the content is stored, for example, in a random access memory (RAM) 53. Then, the process returns to step S10.

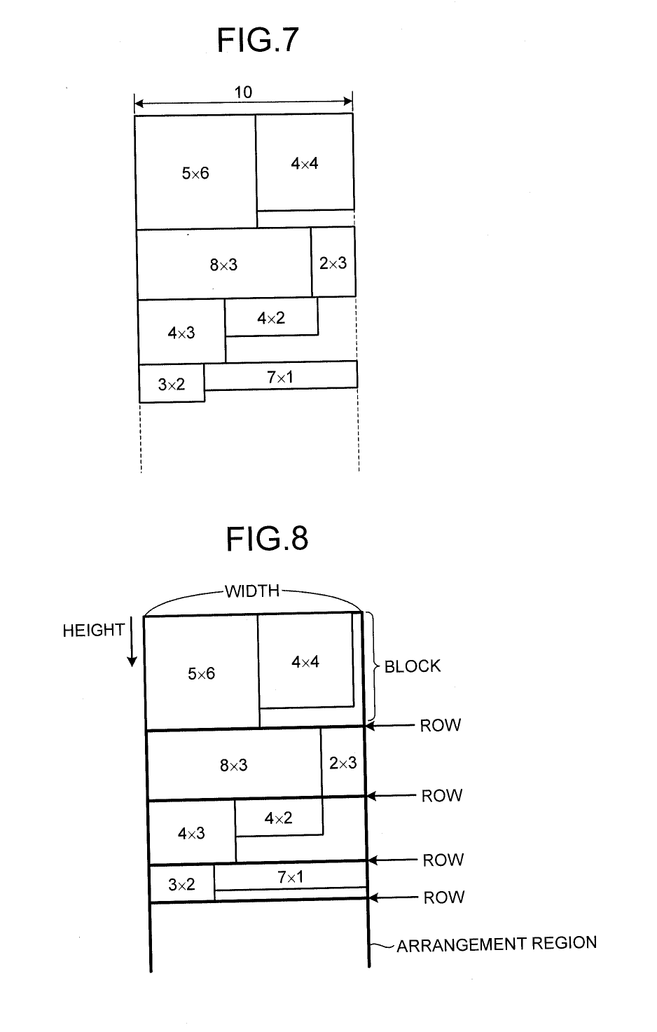

FIG. 7 is a diagram illustrating the close-packed layout generated by the FFDH algorithm using the above described process. In this example, eight contents are arranged on an arrangement region having the width of “10”. The close-packed layout generated in step S2 of FIG. 4 is referred to as an “initial page layout”.

As can be seen from the flowcharts of FIGS. 4 and 6, in the close-packed layout by the FFDH algorithm, a content having a height equal to or smaller than the preceding content is arranged at the right side of the preceding content. Furthermore, when content is arranged at the left end, another content having a height equal to or smaller than the height of the former content is arranged below the former content. Hereinafter, a region, which has a width equal to the width of the arrangement region and of which a height and the position in the height direction of the arrangement region are defined by the upper and lower ends of the content arranged at the left, is referred to as a “block”. A separator between two blocks is referred to as a “row”. FIG. 8 is a diagram illustrating a row in the arrangement region. As illustrated in FIG. 8, the arrangement region is demarcated by a plurality of rows according to the lengths of the rectangular contents.

In the example of FIG. 7, contents are arranged in a row such that the upper ends of the contents are level with one another. However, the present embodiment is not limited thereto, and a series of blocks arranged in a row in a right direction with respect to a block at the left end may have any other arrangement to the extent that the upper and lower ends of the series of blocks do not exceed a range defined by the upper and lower ends of the block at the left end.

In the FFDH algorithm, it is known that the evaluation value on the optimum solution satisfies the following Formula (5). Formula (5) represents an example in which the height and the width of the content are normalized to “1”, respectively. In Formula (5), a value Halg denotes the height required by the FFDH algorithm, and a value Hopt denotes the optimum solution.

Halg≦1.7×Hopt+1 (5)

Generation of Page Layout

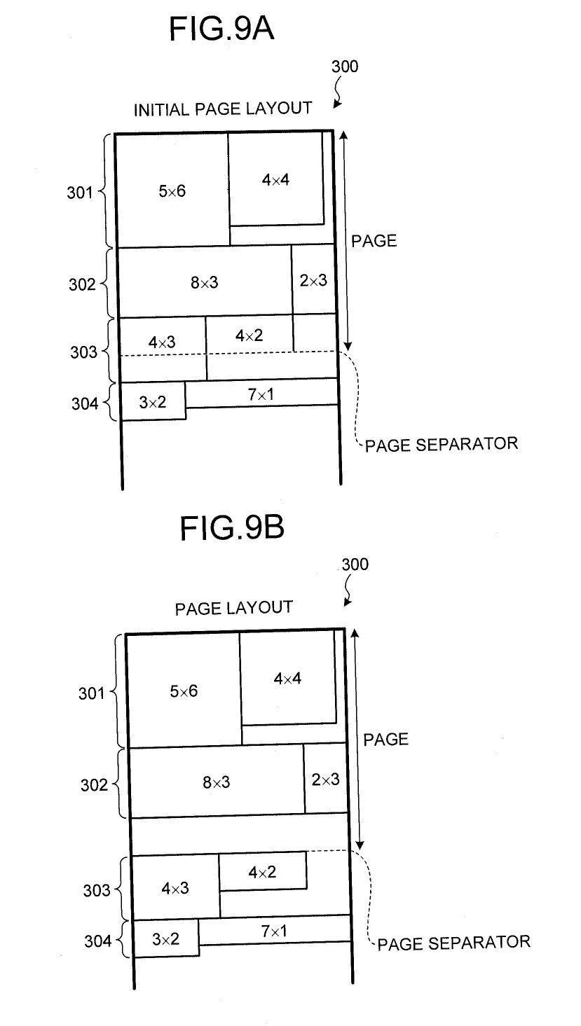

Next, a description will be made in connection with generation of a final layout for each page to be output described in step S3 of FIG. 4. After the initial page layout is generated by the close-packed layout according to the procedure described with reference to FIG. 6 in step S2 of FIG. 4, the arrangement region is divided into units of pages to be output which have the same width as the arrangement region but have a predetermined height. FIGS. 9A and 9B are diagrams illustrating examples in which a block is arranged over different pages. As illustrated in

FIG. 9A, a certain block may be arranged to extend over different pages. In the example of FIG. 9A, among blocks 301 to 304 arranged on an arrangement region 300, the block 303 is arranged to extend beyond the page to be output. In this state, the content is eventually divided in the middle, and thus it is not desirable. For this reason, in the present embodiment, the layout is adjusted so that each block does not extend beyond the page to be output, and the final layout is generated for each page to be output.

In the present embodiment, the block arranged to extend beyond the page to be output is moved to the head of the next page to be output. The next page to be output refers to a page to be output which is next to the page to be output to which the upper end of the block arranged to extend over the different pages to be output belongs. That is, in the example of FIG. 9A, as illustrated in FIG. 9B, the block 303 arranged to extend beyond the page to be output is moved to the head of the next page to be output, and blocks arranged below the block 303 are moved downward with the movement of the block 303. Thereafter, by performing the process on each page to be output sequentially and repeatedly, it is possible to generate the layout in which all the contents are arranged not to extend beyond the pages to be output.

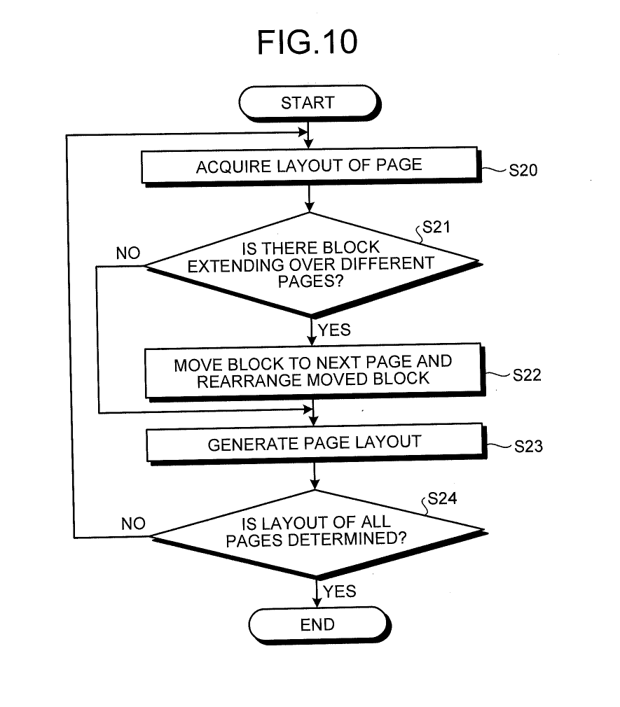

FIG. 10 is a flowchart illustrating a process of an example of a page layout generating method according to the present embodiment. First, in step S20, the layout generating unit 104 acquires the page layout of the page to be output. The page layout acquired in step S20 refers to the layout including the blocks related to the page to be output of the processing target. When the page to be output is a first page, the page layout of the page to be output is acquired from the initial page layout.

In step S21, the layout generating unit 104 determines whether or not a block extending beyond the page is present in the page layout of the page to be output. When it is determined that a block extending beyond the page to be output is not present (No in step S21), the layout generating unit 104 moves the process to step S23.

However, when it is determined in step S21 that a block that extends beyond the page to be output is present in the page layout of the page to be output (Yes in step S21), the layout generating unit 104 moves the process to step S22. In step S22, the layout generating unit 104 moves the block arranged to extend beyond the page to be output and blocks arranged below the block downward and rearranges the blocks so that the block having been arranged to extend beyond the page to be output in the layout of the page to be output can be arranged at the head of a page to be output next to the page to be output. When the rearrangement of the blocks has been completed, the layout generating unit 104 moves the process to step S23.

In step S23, the layout generating unit 104 generates the page layout of the page to be output according to an arrangement state of the current blocks and determines the page layout of the page to be output. Then, the layout generating unit 104 moves the process to step S24, where the layout generating unit 104 determines whether or not the page layout has been determined on all of the pages to be output. When it is determined that there is an page to be output whose page layout has not been determined yet (No in step S24), the layout generating unit 104 returns the process to step S20. In step S20, the next page to be output whose page layout is determined in step S23 is set as the page to be output, and the process is repeated.

However, in step S24 when it is determined that the page layout has been determined on all of the pages to be output (Yes in step S24), the layout generating unit 104 ends a series of processes. In this case, when a non-arranged block is not present, the layout generating unit 104 determines that the page layout has been determined on all of the pages to be output.

As described above, according to the present embodiment, when contents having various sizes are arranged over a plurality of pages, the number of pages to be output is reduced as much as possible, and the layout in which the content is not divided by the pages to be output can be automatically generated.

When contents having various sizes are arranged on the arrangement region, it is difficult to guarantee that it is possible to limit the page to be output so that no content extends beyond the page to be output, and there is a high possibility that content will be arranged to extend over the page to be output. That is, in order to draw a line in a width direction (a page separator) so that a content is not limited in a state in which a content is arranged, a condition is required, for example, of making upper sides or lower sides of contents have the same height when seen in the width direction. FIG. 9A is a diagram illustrating an example in which blocks are efficiently arranged but an appropriate page separator is not found.

In this embodiment, as an example of the layout process by the layout generating unit 104, the arrangement method using the FFDH algorithm has been described using the flowchart of FIGS. 4 and 6. However, the present embodiment is not limited thereto. For example, the layout generating unit 104 may generate the layout by a method of classifying contents into monochrome contents and color contents. In addition, the layout generating unit 104 may generate the layout based on structured information of an original Web page.

Returning to FIG. 3, in step S202, the print data generating unit 108 acquires the bitmap data laid out on the page to be output, and generates the print data afterward (step S203).

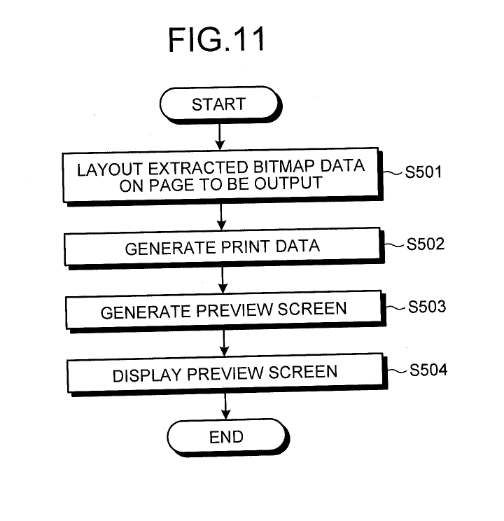

Next, a description will be made in connection with a procedure of a preview display process by the information processing apparatus 100. FIG. 11 is a flowchart illustrating a procedure of a preview display process.

The layout generating unit 104 lays out the bitmap data of the corresponding region extracted by the extracting unit 107 on the page to be output (step S501). Then, the print data generating unit 108 generates the print data (step S502).

The preview screen generating unit 111 generates a preview screen of the print data generated by the print data generating unit 108 (step S503). The display control unit 106 displays the preview screen generated by the preview screen generating unit 111 on the display unit 105 (step S504). For example, the preview screen generating unit 111 displays a file described in a page description language for a Web page (for example, html) on the same Web browser.

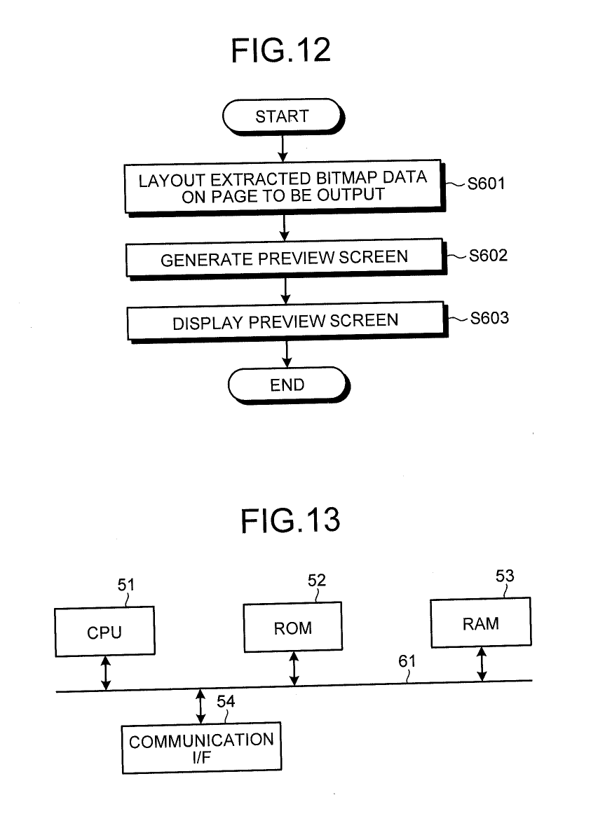

Next, a description will be made in connection with another example of a preview display process by the information processing apparatus 100. FIG. 12 is a flowchart illustrating a procedure of a preview display process according to another example.

A process of step S601 is the same as the process of step S501 of the flowchart of FIG. 11. A process of step S602 is also the same as the process of step S503 of the flowchart of FIG. 11. A process of step S603 is the same as the process of step S504 of FIG. 11.

That is, in the preview display process according to another example illustrated in FIG. 12, the process of step S502 of the flowchart of FIG. 11 is not performed. In step S502 of the flowchart of FIG. 11, the preview screen generating unit 111 has generated the preview screen in which the layout result is reflected at preview timing. However, as illustrated in FIG. 12, the preview screen generating unit 111 may generate an image in which each bitmap data is arranged on the html and display the image on the Web browser instead of generating the preview screen of the print data. In this case, the print data generating unit 108 generates the print data after an output instruction is given, and thus a preview display time can be reduced.

The Web page print support system having the above described configuration may be implemented, for example, as a plug-in function of the browser or the like. In this case, the display control unit 106 displays an interface (I/F) including a layout execution button added to a tool bar on the display unit 105. The receiving unit 103 recognizes that the user has pressed down the layout execution button. The display control unit 106 receives the instructions resulting from the pressed button from the receiving unit 103 displays a layout result on the browser. Then, when the receiving unit 103 recognizes that the user presses the layout execution button again, the layout generating unit 104 generates a different layout from the initially generated layout and causes the generated layout to be displayed by the display control unit 106. By repeating a series of processes described above, the Web page print support system can present the user with a desired layout result.

As described above, according to the present embodiment, the output region is designated from the image of the bitmap data having been converted from the Web page information, the corresponding region is extracted from the bitmap data, and the layout is performed. Thus, only contents which the user designates from the Web page can be laid out.

Next, a hardware configuration of the information processing apparatus according to the present embodiment will be described with reference to FIG. 13. FIG. 13 is a diagram for explaining a hardware configuration of the information processing apparatus according to the present embodiment.

As illustrated in FIG. 13, the information processing apparatus 100 according to the present embodiment includes a control device such as a central processing unit (CPU) 51, a storage device such as a read only memory (ROM) 52 and the RAM 53, a communication interface (I/F) 54 which is connected to a network and performs communications, an external storage device such as a hard disk drive (HDD) or a compact disc (CD) drive device, a display device, an input device such as a keyboard or a mouse, and a bus 61 that connects the respective components with one another. That is, the information processing apparatus 100 has a hardware configuration using a conventional computer.

A layout generating program executed by the information processing apparatus 100 according to the present embodiment may be a file in an installable or executable format, and may be recorded in a computer readable recording medium such as a compact disk read only memory (CD-ROM), a flexible disk (FD), a compact disk recordable (CD-R), and a digital versatile disk (DVD), and thus be provided as a computer program product.

A layout generating program executed by the information processing apparatus 100 according to the present embodiment may be stored in a computer connected to a network such as the Internet and provided as being downloaded via a network. A layout generating program executed by the information processing apparatus 100 according to the present embodiment may be provided or distributed via a network such as the Internet.

A layout generating program according to the present embodiment may be provided as being embedded in a read only memory (ROM) or the like in advance.

A layout generating program executed by the information processing apparatus 100 according to the present embodiment may have a module configuration including the above described components (the converting unit 102, the display control unit 106, the receiving unit 103, the extracting unit 107, and the layout generating unit 104). In actual hardware, by reading out and executing the layout generating program from the storage medium through the CPU 51 (a processor), the above described components are loaded onto a main storage device, so that the above described components are generated on the main storage device.

According to the present embodiment, there is an effect capable of easily generating a document in which only desired contents are collected from a Web page.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a converting unit that converts acquired Web page information into bitmap data;
a display control unit that displays, on a display unit on which the Web page information has been displayed, an image of the converted bitmap data by switching from the Web page information to the image;
a receiving unit that receives an input for designating an output region as an output target from the displayed image;
an extracting unit that extracts a corresponding region corresponding to the received output region from the bitmap data; and
a layout generating unit that generates layout information representing a layout to arrange the extracted corresponding region on a page to be output.

2. The information processing apparatus according to claim 1, wherein
the receiving unit receives a designation of a plurality of output regions, and
the layout generating unit generates the layout information according to a predetermined sort order.

3. The information processing apparatus according to claim 2, wherein
the sort order is a descending order of length of the output regions, and
the layout generating unit generates the layout information representing a layout in which the plurality of output regions are arranged in a free space of the page to be output in the descending order of length of the output regions.

4. The information processing apparatus according to claim 1, wherein
the Web page information includes structure information, and
the layout generating unit generates a layout based on the structure information.

5. A layout generating method comprising:
converting acquired Web page information into bitmap data;
display controlling to display, on a display unit on which the Web page information has been displayed, an image of the converted bitmap by switching from the Web page information to the image;
receiving an input for designating an output region as an output target from the displayed image;
extracting a corresponding region corresponding to the received output region from the bitmap data; and
generating layout information representing a layout to arrange the extracted corresponding region on a page to be output.

6. A computer program product comprising a non-transitory computer-usable medium having a computer-readable program code embodied in the medium causing a computer to execute:
converting acquired Web page information into bitmap data;
display controlling to display, on a display unit on which the Web page information has been displayed, an image of the converted bitmap by switching from the Web page information to the image;
receiving a designation input of an output region as an output target from the displayed image;
extracting a corresponding region corresponding to the received output region from the bitmap data; and
generating layout information representing a layout to arrange the extracted corresponding region on a page to be output.
